(19) United States
(12) Patent Application Publication
(10) Pub. No.: US 2006/0245341 A1
(43) Pub. Date: Nov. 2, 2006

(54) REUSABLE STAMPER FOR OPTICAL DISK

(75) Inventor: Helfried Weinzerl, Seal Beach, CA (US)

Correspondence Address: PEARNE & GORDON LLP, 1801 EAST 9TH STREET, SUITE 1200, CLEVELAND, OH, 44114-3108, US

(73) Assignee: Unaxis Balzers Ltd., Balzers (LI)

(21) Appl. No.: 11/380,979

(22) Filed: May 1, 2006

Related U.S. Application Data
(60) Provisional application No. 60/677,018, filed on May 2, 2005.

(51) Int. Cl. G11B 7/24

(52) U.S. Cl. 369/275.1

(57) ABSTRACT

A disk for optical storage media is being embossed with information during the injection molding process on both sides. Using 2 such disks, a reflective coating is being applied on the front side of the first disk and a resin layer is being applied on said reflective coating. Then the back side of said second disk is being pressed into the resin layer to transfer the embossed information to the first disk. After separating said second disk from the first one the second disk is being used as first substrate in a subsequent process, thereby avoiding any waste stamper disk.

### FIELD OF THE INVENTION

The invention relates to so called multilayer disks, i. e. optical storage disks, which are read from the first surface; i.e. the optical path of a read-out laser does not enter the substrate itself; in particular the invention applies to Blu-Ray Dual Layer Disks.

### RELATED ART

Dual Layer Disks such as DVD-R DL or Blu-Ray Disks can be realized by an embossing process.

In case of Blu-Ray, this process comprises (a) coating a substrate (with embossed information) with a reflective coating, (b) applying a thermoplastic layer of about 20 micrometer thickness, (c) embossing the second information layer by hot pressing or photo polymerization, (d) coating this embossed information layer with a semi reflective layer and finally (e) adding a cover layer. A variation of this technology is the so called 2P-process, which consists in the steps of depositing a reflective layer on a substrate, applying a photopolymer resin, embossing the second data surface with a stamper and hardening the photopolymer with UV light, finally remove the stamper and metallize the embossed surface as before. The stamper is usually made of a plastic material with very low adhesion like PMMA or polyolefins. This stamper has to be removed from the (coated) substrate before further processing.

The 2P-process can also be used in the production of disks with more than 2 layers by repeating the process steps described above.

The disadvantage of the current processes in place is the need of a separate “stamper” to emboss the second information layer. This separate stamper can be of re-usable nature or of use-once nature (e.g. PMMA as used for DVD18—see also U.S. Pat. No. 6,117,284). However, in any case, this stamper is made today by an additional process for the production of the stamper, which is an additional part different from the disk substrate itself It is therefore an objective of the invention to overcome the problems known in the art, especially to propose a possibility to avoid a separate stamper to be wasted after a single use.

### SOLUTION ACCORDING TO THE INVENTION

This invention uses the disk substrate itself as the stamper at the same time.

It uses the back side of the disk—which has no optical function—as the stamper for the second information layer; i.e. the substrate will be molded so that there is the first information layer on the front side of the substrate and the second information layer on the back side of the substrate (this is the one, which will be printed at the end of the disk replication process).

A respective process for manufacturing an optical storage disc will comprise the following steps:

(a) Providing a first substrate with a first surface on a front side and a second surface on a back side, both surfaces showing embossed information

(b) Providing a second substrate with substantial the same surface properties

(c) Applying a reflective coating on the front side of the first substrate

(d) Applying a resin layer on said reflective coating

(e) Pressing the back side of said second substrate into said resin layer to transfer said embossed information to said first substrate

(f) Separating said second substrate from said first substrate; and

(g) Using said second substrate as first substrate in a subse quent process according to this claim. Further embodiments and features of the invention are described in its dependent claims.

### BRIEF DESCRIPTION OF THE DRAWINGS

FIG. 1 shows a cutout from a disk according to the invention

FIG. 2 shows an information transfer step according to an embodiment of the invention

FIG. 3 shows an information transfer step according to a further embodiment of the invention

### DETAILED DESCRIPTION OF THE INVENTION

There are basically two different process sequences, depending on the question, when and where the semi reflective layer is coated:

1. After molding, the back side of the substrate will first function as a “stamper”; i e press the information into the front side of another substrate which already has been coated with a reflective layer and the resin and be separated again from the other substrate; and then later on be coated itself with the reflective layer and the resin before being embossed and finally coated with the semi reflective layer and the cover layer.

2. After molding, the back side of the substrate will first be coated with the semi reflective material before functioning as a “stamper”; i.e press the information into the front side of another substrate which already has been coated with a reflective layer and the resin—during separation from this substrate, the semi reflective layer will be transferred to the other substrate; and then later on be coated itself with the reflective layer and the resin before being embossed and receiving the semi reflective layer and finally coated with the cover layer.

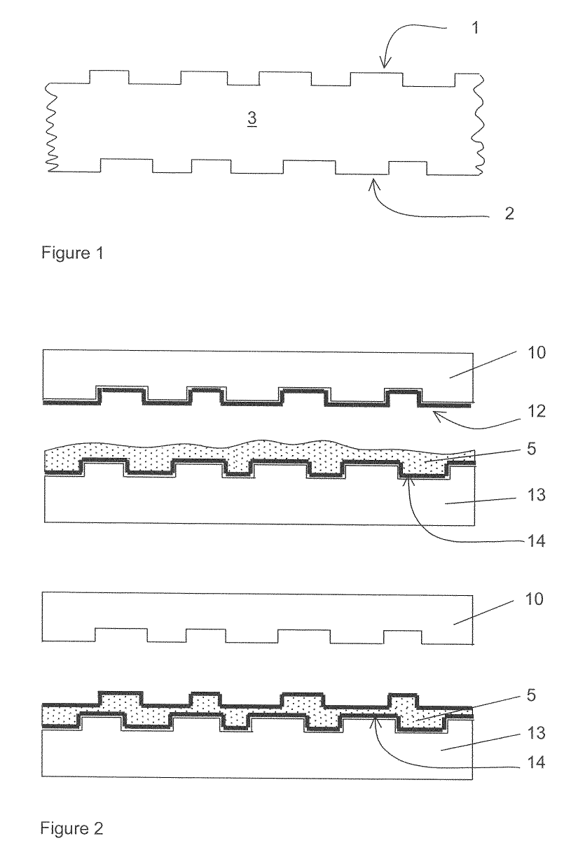

FIG. 1 shows schematically a cutout from a disk substrate 3 according to the invention It has a front side with a first surface 1 and back side with a second surface 2.

FIG. 2 shows the step of transfer of the information Reference numeral 13 identifies a first disk substrate with its front side (back side not shown), 10 is a second disk substrate with its backside shown (front side omitted). The front side of said first disk 13 is covered with a reflective layer 14, which again is covered by a resin 5 Pressing disks 13 and 10 together will transfer the semi reflective layer 12 from disk 10 to 13. After separating (lower part of FIG. 2) the disks disk substrate 13 can be finalized, whereas substrate 10 will be reused as described.

The Advantages:
There is only one molding process for one substrate; i.e. reduces the investment costs and simplifies the production line layout and reduces the footprint.
less material needed for molding—saving in running costs
no extra plastic “trash”—no need for recycling

As a substrate, various materials are being considered and used. There is a wide range of materials to choose from, since the optical path does not pass the substrate and thus, the substrate does not have to show certain optical properties regarding transparency etc.

Depending on the substrate used and whether one uses production method (1) or (2), it will be more or less difficult to separate the “stamper” side from the “active” side after embossing without damaging the embossed information. Some substrate materials as e.g. Poly-carbonate may favor to use a “anti-adhesive” layer as suggested in patent application WO 06/002561 (Carbon Layer), so that the separation will be smooth and the embossed layer will be functional.

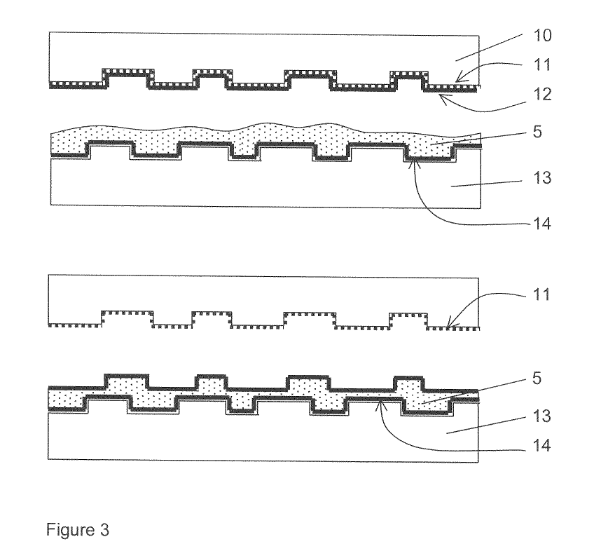

FIG. 3 shows a variant of the transfer step described in FIG. 2. The numerals already used have the same meaning as in FIG. 2. In FIG. 3 however, the back side of disk substrate 10 has an anti-adhesive layer 11 between semi reflective layer 12 and substrate 10. This allows transferring layer 12 onto disk 13 without damaging layer 12.

In summary: A Disk for optical storage media is being embossed with information during the injection molding process, i. e. on both sides of the injection-molding-machine an active stamper is being used In a first step of the invention a first side of this disk is being used as a stamper to form an information layer. Then the other side of the disk provides a basis for the next optical disk

This way the grooves/bits, forming a part of the information layer, are being turned outside. This does no harm, since this side will normally be covered with lacquer in a later production step.

The material for the disk substrate is not subject to specific limitations, since it does not form part of the optical path later. However, adhesion may be an issue, e. g. with PMMA or Zeonor substrates. In the basic 2P process the substrate must show poor adhesion to detach the information layer from the stamper. Later on, when the inventive substrate is used a second time, adhesiveness should be high. This however can be achieved by different measures, e. g. plasma activation or chemical treatment.

Advantages

The former “dummy” disk needs not to be disposed of, but can be reused a second time as a substrate. This of course saves material and time. Further only one injection molding machine is necessary, whereas usually 2 have to be used per production line.

What is claimed is:

1. Process for manufacturing an optical storage disc comprising the following steps:
(a) Providing a first substrate (3, 13) with a first surface (1) on a front side and a second surface (2) on a back side, both surfaces showing embossed information
(b) Providing a second substrate (10) with substantial the same surface properties
(c) Applying a reflective coating (14) on the front side of the first substrate (13)
(d) Applying a resin layer (5) on said reflective coating (14)
(e) Pressing the back side of said second substrate (10) into said resin layer (5) to transfer said embossed information to said first substrate (13)
(f) Separating said second substrate (10) from said first substrate (13); and
(g) Using said second substrate as first substrate in a subsequent process according to this claim.

2. Process according to claim 1, wherein after step (b) said second substrate (10) is being coated on its back side with a semi reflective layer (12), said semi reflective layer being transferred as part of the information in step (e)

3. Process according to claim 2, wherein an anti-adhesive layer (11) is being applied between the back side and said semi reflective layer 12).

4. Process according to claim 1, wherein after step (f) the resin layer of said first substrate is being coated with a semi reflective layer.

5. Process according to claim 2 or 4, wherein a cover layer is being applied on said first substrate's semi reflective layer.

6. Process according to claim 1, wherein the back side of said first substrate finally is being printed or covered with lacquer.

7. Process according to claim 3, wherein the anti-adhesive layer (11) comprises carbon.
